(19) United States
(12) Patent Application Publication
(10) Pub. No.: US 2026/0012376 A1
(43) Pub. Date: Jan. 8, 2026

(54) SIGNAL PROCESSING APPARATUS

(71) Applicant: NEC Corporation, Tokyo (JP)

(72) Inventor: Junki YARITA, Toyota (JP)

(73) Assignee: NEC Corporation, Tokyo (JP)

(21) Appl. No.: 19/245,712

(22) Filed: Jun. 23, 2025

(30) Foreign Application Priority Data
Jul. 4, 2024 (JP) 2024-108079

(51) Int. Cl. H04L 25/02; H04L 25/03; H04L 27/26

(52) U.S. Cl. CPC H04L 25/0202; H04L 25/03006; H04L 27/2614

(57) ABSTRACT

A signal processing apparatus of the present disclosure includes: a detecting unit configured to detect, based on intensity of a frequency component in a superimposed signal containing a plurality of signals, a first peak with highest intensity and a second peak with lower intensity than the first peak in at least one signal to be separated contained by the superimposed signal; and an estimating unit configured to estimate a preset type of signal parameter of the signal to be separated by using information based on the first peak and the second peak.

### INCORPORATION BY REFERENCE

This application is based upon and claims the benefit of priority from Japanese patent application No. 2024-108079, filed on Jul. 4, 2024, the disclosure of which is incorporated herein in its entirety by reference.

### TECHNICAL FIELD

The present disclosure relates to a signal processing apparatus.

### BACKGROUND ART

In recent years, wireless communication systems have been required to improve frequency utilization efficiency to effectively leverage limited radio resources. Therefore, it is desirable to transmit a superimposed signal including a plurality of signals on the same frequency. In this case, receivers need to have a function to easily separate the superimposed signal.

For example, Patent Literature 1 describes a method for separating a superimposed signal received on a single channel. Moreover, Non-Patent Literature 1 describes a method that simultaneously estimates a plurality of signal sequences by using Maximum Likelihood Sequence Estimation (MLSE) and separates the plurality of signal sequences.

### CITATION LIST

### Patent Literature

[Patent Literature 1] Japanese Unexamined Patent Application Publication No. JP 2013-197775A

### Non-Patent Literature

[Non-Patent Literature 1] K. Giridhar, S. Chari, J. J. Shynk and R. P. Gooch, “Joint demodulation of cochannel signals using MLSE and MAPSD algorithms”, Proc. IEEE Int. Conf. Acoust. Speech Signal Processing, pp. 160-163, April 1993.

### SUMMARY OF INVENTION

### Technical Problem

However, the method of separating a superimposed signal described in Patent Literature 1 mentioned above has a problem in that the separation accuracy deteriorates when the power difference between the signals is small because it utilizes the power difference to demodulate and cancel the signals in order from the highest power. Moreover, the method of separating a superimposed signal described in Non-Patent Literature 1 mentioned above assumes that signal parameters such as the amplitude and the symbol timing for each signal are known, but it is difficult to estimate the signal parameters for signals with small power difference contained in the superimposed signal as mentioned above. Therefore, there is a problem that it is not possible to achieve improvement of the accuracy in separation of a superimposed signal.

Accordingly, an object of the present disclosure is to solve the aforementioned issue of being unable to achieve improvement of the accuracy in separation of a superimposed signal.

### Solution to Problem

A signal processing apparatus as an aspect of the present disclosure includes: a detecting unit configured to detect, based on intensity of a frequency component in a superimposed signal containing a plurality of signals, a first peak with highest intensity and a second peak with lower intensity than the first peak in at least one signal to be separated contained by the superimposed signal; and an estimating unit configured to estimate a preset type of signal parameter of the signal to be separated by using information based on the first peak and the second peak.

Further, a signal processing method as an aspect of the present disclosure includes: detecting, based on intensity of a frequency component in a superimposed signal containing a plurality of signals, a first peak with highest intensity and a second peak with lower intensity than the first peak in at least one signal to be separated contained by the superimposed signal; and estimating a preset type of signal parameter of the signal to be separated by using information based on the first peak and the second peak.

Further, a program as an aspect of the present disclosure includes instructions for causing a computer to execute processes to: detect, based on intensity of a frequency component in a superimposed signal containing a plurality of signals, a first peak with highest intensity and a second peak with lower intensity than the first peak in at least one signal to be separated contained by the superimposed signal; and estimate a preset type of signal parameter of the signal to be separated by using information based on the first peak and the second peak.

### Advantageous Effects of Invention

With the configurations as described above, the present disclosure can achieve improvement of the accuracy in separation of a superimposed signal.

### BRIEF DESCRIPTION OF DRAWINGS

FIG. 1 is a block diagram showing a configuration of a signal processing apparatus according to the present disclosure.

FIG. 2 is a flowchart showing an example of processing operation of the signal processing apparatus according to the present disclosure.

FIG. 3 is a diagram showing an example of a state of processing by the signal processing apparatus according to the present disclosure.

FIG. 4 is a diagram showing an example of a state of processing by the signal processing apparatus according to the present disclosure.

FIG. 5 is a diagram showing an example of a state of processing by the signal processing apparatus according to the present disclosure.

FIG. 6 is a block diagram showing an example of the configuration of the signal processing apparatus according to the present disclosure.

FIG. 7 is a block diagram showing an example of a hardware configuration of a signal processing apparatus according to the present disclosure.

FIG. 8 is a block diagram showing an example of a configuration of the signal processing apparatus according to the present disclosure.

### EXAMPLE EMBODIMENTS

### First Example Embodiment

A first example embodiment of the present disclosure will be described with reference to the drawings. The drawings may be related to any example embodiment.

### [Configuration]

A signal processing apparatus 10 of the present disclosure is used to estimate a signal parameter of each signal used when separating a superimposed signal containing a plurality of signals into individual signals. A superimposed signal processed by the signal processing apparatus 10 is, for example, a superimposed signal used in wireless communication such as satellite communication, and may be received on a single channel. At this time, the signal processing apparatus 10 can handle a case where the power difference between signals contained in a superimposed signal is small, as will be described later. The signal processing apparatus 10 may process any superimposed signal such as a superimposed signal used in wired communication and optical communication.

In the following, this example embodiment will describe, as an example, a case where a superimposed signal containing two signals (first signal and second signal) is a processing target and the amplitude and the symbol timing that are preset types of signal parameters of each of the two signals as the separation targets are estimated. However, the signal processing apparatus 10 may process a superimposed signal containing even more signals as the targets, and estimate the signal parameters of each of the signals.

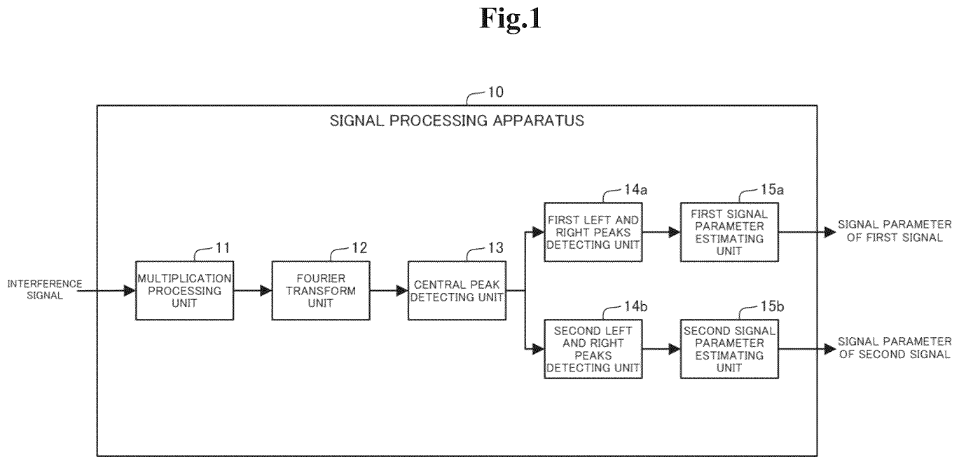

The signal processing apparatus 10 in this example embodiment is configured with one or more information processing apparatuses each including an arithmetic logic unit and a memory unit. As shown in FIG. 1, the signal processing apparatus 10 includes a multiplication processing unit 11, a Fourier transform unit 12, a central peak detecting unit 13, a first left and right peaks detecting unit 14a, a second left and right peaks detecting unit 14b, a first signal parameter estimating unit 15a, and a second signal parameter estimating unit 15b. The respective functions of the multiplication processing unit 11, the Fourier transform unit 12, the central peak detecting unit 13, the first left and right peaks detecting unit 14a, the second left and right peaks detecting unit 14b, the first signal parameter estimating unit 15a, and the second signal parameter estimating unit 15b can be implemented by execution of a program for implementing the respective functions stored in the memory unit by the arithmetic logic unit. Moreover, a receiving device, which is not illustrated, is connected to the signal processing apparatus 10. The respective components will be described below, but the functions of the respective components will be described in detail later in the operation description.

The receiving device (not illustrated) connected to the signal processing apparatus 10 inputs a superimposed signal that is a reception signal received by an antenna into the signal processing apparatus 10. Specifically, the receiving device performs various receiving processes such as a filtering process, an amplification process and a mixing process on the reception signal, and inputs the in-phase component and the quadrature component of the superimposed signal converted to the baseband into the signal processing apparatus 10.

The multiplication processing unit 11 (converting unit) receives an input of a superimposed signal from the aforementioned receiving device and multiplies the superimposed signal. Then, the multiplication processing unit 11 outputs the multiplied superimposed signal, that is, a multiplied waveform to the Fourier transform unit 12.

The Fourier transform unit 12 (converting unit) performs a Fourier transform on the multiplied waveform, which is the multiplied superimposed signal. In other words, the Fourier transform unit 12 converts the multiplied superimposed signal to the intensity of the frequency component. Then, the Fourier transform unit 12 outputs the result of the Fourier transform of the multiplied superimposed signal to the central peak detecting unit 13.

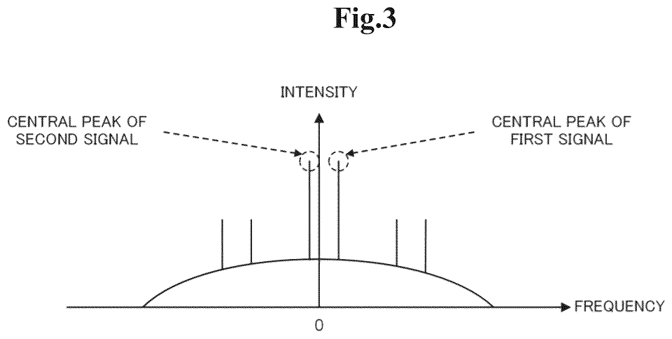

The central peak detecting unit 13 (detecting unit) detects a peak around the center of each of the signals contained in the superimposed signal based on the Fourier transform result. In this example embodiment, as shown in FIG. 3, the central peak detecting unit detects a central peak (first peak) where the intensity is at maximum for each of a first signal and a second signal, which are the two signals contained in the superimposed signal. Then, the central peak detecting unit 13 outputs information of the detected first signal central peak to a first left and right peaks detecting unit 14a, and outputs information of the detected second signal central peak to a second left and right peaks detecting unit 14b.

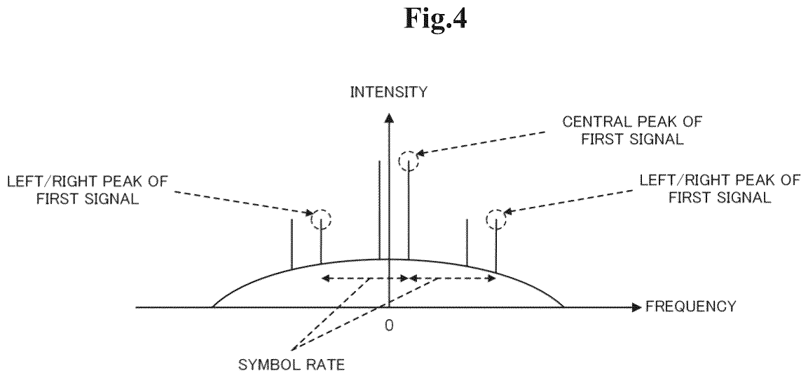

The first left and right peaks detecting unit 14a and the second left and right peaks detecting unit 14b (detecting unit) each detect left and right peaks (second peak) with lower intensity than the central peak of the signal, from the Fourier transform result and the result of detection of the central peak of the signal. Specifically, as shown in FIG. 4, the first left and right peaks detecting unit 14a detects left and right peaks that appear on the left and right sides of the frequency of the central peak of the first signal, namely, on the high frequency side and the low frequency side with respect to the frequency of the central peak, from the Fourier transform result. In this example embodiment, the first left and right peaks detecting unit 14a only needs to detect at least one of the left and right peaks respectively detected on the left and right sides of the central peak in FIG. 4. Then, the first left and right peaks detecting unit 14a outputs information of the detected left and right peaks to the first signal parameter estimating unit 15a. Moreover, in the same manner as the aforementioned first left and right peaks detecting unit 14a, the second left and right peaks detecting unit 14b detects at least one of the left and right peaks that respectively appear on the left and right side of the central peak of the second signal, from the Fourier transform result, and outputs information of the detected left and right peaks to the second signal parameter estimating unit 15a.

The first signal parameter estimating unit 15a and the second signal parameter estimating unit 15b (estimating unit) each estimate the signal parameters of the signal based on the result of detection of the central peak and the result of detection of the left and right peaks of the signal. In this example embodiment, the first signal parameter estimating unit 15a estimates the amplitude and the symbol timing of the first signal as the signal parameters, and the second signal parameter estimating unit 15b estimates the amplitude and the symbol timing of the second signal as the signal parameters. Specifically, the first signal parameter estimating unit 15a calculates the amplitude of a carrier component of the first signal and the amplitude and phase of an amplitude modulation signal component with respect to the carrier component from the detection results of the central peak and the left and right peaks of the first signal, and calculates a first signal parameter by using the calculated information. Likewise, the second signal parameter estimating unit 15b calculates the amplitude of a carrier component of the second signal and the amplitude and phase of an amplitude modulation signal component with respect to the carrier component, from the detection results of the central peak and the left and right peaks of the second signal, and calculates a second signal parameter by using the calculated information. Then, the first signal parameter estimating unit 15a and the second signal parameter estimating unit 15b output the signal parameters estimated for the respective signals. For example, when the signal parameter is output to a separation processing device that separates each signal from a superimposed signal, the separation processing device can thereby separate each signal from the superimposed signal by using the signal parameter by the method as described in Non-Patent Literature 1 mentioned above. The signal parameter to be estimated may be preset other types of parameters as necessary.

### [Operation]

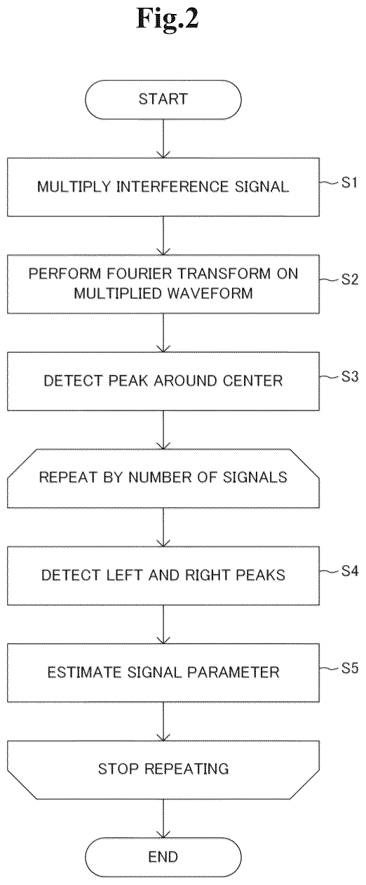

Next, the processing operation by the abovementioned signal processing apparatus 10 will be described. First, the signal processing apparatus 10 causes the multiplication processing unit 11 to multiply an input superimposed signal (step S1 of FIG. 2). At this time, a multiplication factor is appropriately selected according to a signal modulation method. For example, in phase shift keying (PSK), the number of signal points is used as the multiplication factor. Thus, all the signal points after multiplication are in phase, resulting in the appearance of a carrier frequency component.

Next, the signal processing apparatus 10 causes the Fourier transform unit 12 to perform a Fourier transform on a multiplied waveform obtained by multiplying the superimposed signal (step S2 of FIG. 2).

Next, the signal processing apparatus 10 causes the central peak detecting unit 13 to detect central peaks, which are intensity peaks around the centers of the first signal and the second signal contained in the superimposed signal from the Fourier transform results (step S3 of FIG. 2). Here, even if the signals use the same frequency, the central frequencies differ slightly due to individual differences in transmitters, Doppler shift, and so forth. Therefore, as shown in FIG. 3, it is possible to separate and detect the respective peaks of the first signal and the second signal. At this time, let the Fourier coefficient of the central peak of an n^{th} signal be r_{n,0}exp (jθ_{n,0}).

Next, the signal processing apparatus 10 causes the first left and right peaks detecting unit 14a to detect the left and right peaks of the first signal from the Fourier transform result and the result of detection of the central peak of the first signal (step S4 of FIG. 2). Here, the left and right peaks refer to peaks that appear around ±symbol rate with respect to the central peak of each signal. At this time, let the Fourier coefficients of the left and right peaks of the n^{th} signal be r_{n,-1}exp (jθ_{n,-1}) for the low-frequency side and r_{n,1}exp(jθ_{n,1}) for the high-frequency side, respectively. The first left and right peaks detecting unit 14a selects one of the Fourier coefficients of the left and right peaks, and outputs information of either the left or right peak to the first signal parameter estimating unit 15a. As an example of a selection method, a method of comparing r_{n,1} and r_{n,-1} and selecting the larger value is considered. Moreover, in the same manner as described above, the signal processing apparatus 10 causes the second left and right peaks detecting unit 14b to detect the left and right peak frequencies of the second signal from the Fourier transform result and the result of detection of the central peak of the second signal (step S4 of FIG. 2) and output to the second signal parameter estimating unit 15b.

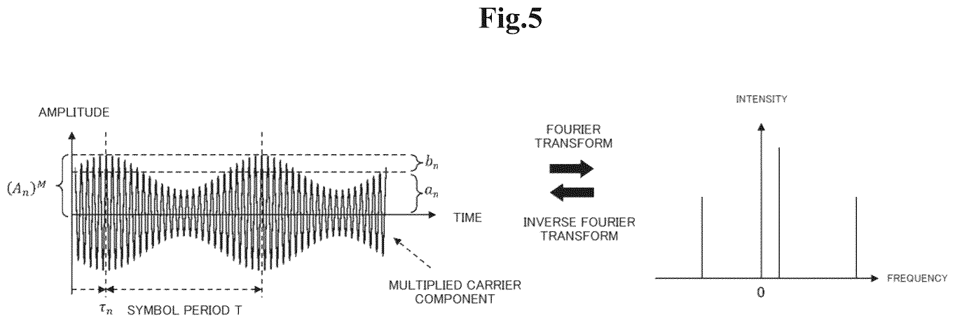

The three peaks, consisting of the central peak and the left and right peaks for each signal mentioned above, can be regarded as the frequency components of a waveform obtained by amplitude modulation with a sine wave having the same period as the symbol period on the multiplied carrier wave, as shown in FIG. 5. The carrier component extracted from the multiplied waveform has an amplitude that varies at the symbol period, resulting in appearance of a frequency component offset by an integral multiple of the symbol rate. However, due to the original signal being band-limited, a frequency component offset by more than double the symbol rate is sufficiently small and can be ignored. In the multiplied waveform, all the signal points align in phase at the symbol timing, so that the timing when the amplitude modulation waveform reaches its maximum amplitude becomes the symbol timing, and the amplitude at that point corresponds to an amplitude obtained by raising the amplitude of the original signal to the multiplication factor power. Thus, the left and right peaks are derived from the carrier frequency, symbol timing, and amplitude of a signal to be separated.

Next, the signal processing apparatus 10 causes the first signal parameter estimating unit 15a to estimate the signal parameter of the first signal from the results of detection of the central peak and the left and right peaks of the first signal (step S5 of FIG. 2). Here, regarding the aforementioned amplitude modulation waveform, let the amplitude of the carrier component be an, the phase be θ_{n,c}, the amplitude of the sinusoidal signal wave component be bₙ, and the phase be θₙ, the amplitude modulation waveform can be expressed as (aₙ+bₙ cos(ωₙ+θₙ))exp(j(ω_{n,c}t+θ_{n,c})). At this time, since aₙ=r_{n,0}, bₙ=2r_{n,1}=2r_{n,-1}, θₙ=−θ_{n,0}+θ_{n,1}=θ_{n,0}−θ_{n,-1} hold, it is possible to determine aₙ, bₙ, and θₙ, respectively. Also, let the symbol period be T and the multiplication power be M, Formulas 1 and 2 below hold for the amplitude Aₙ and symbol timing τₙ of the n^{th} signal.

$${A}_{n} = \sqrt[M]{{a}_{n} + {b}_{n}} \qquad [ Formula 1 ]$$

$${τ}_{n} = \frac{- {θ}_{n} T}{2 π} \qquad [ Formula 2 ]$$

That is to say, the amplitude Aₙ of the original n^{th} signal can be obtained by taking the m^{th} root of (aₙ+bₙ), and the symbol timing τₙ of the original n^{th} signal can be obtained by dividing θₙ by 2π and multiplying by the symbol period T.

As described above, the first signal parameter estimating unit 15a can determine the amplitude and symbol timing, which are the signal parameters of the first signal, from the results of detection of the central peak and the left and right peaks. Likewise, for the second signal, the second signal parameter estimating unit 15b estimates the amplitude and symbol timing that are the signal parameters of the second signal, from the results of detection of the central peak and the left and right peaks (step S5 of FIG. 2).

Thus, according to this example embodiment, it is possible to estimate the signal parameter of each signal contained in a superimposed signal. In particular, in this example embodiment, the peaks of the frequency components originating from the two signals of the superimposed signal are detected and the signal parameters are determined separately, so that even when the power difference between the signals contained in the superimposed signal is small, the signal parameter can be estimated. Further, in this example embodiment, by focusing on the left and right peaks that appear when Fourier transform is performed on the multiplied waveform of the superimposed signal, the need for a resampling process as preprocessing, which is required for signal parameter estimation that utilizes the periodicity appearing when the sampling rate is the integral multiple of the symbol rate, is eliminated, and it is possible to estimate the signal parameter with less calculation amount. Then, by using the estimated signal parameter of each signal, it is possible to separate the superimposed signal, for example, by the separation method as shown in Non-Patent Literature 1. As a result, improvement of the accuracy of separation of the superimposed signal can be achieved.

In this example embodiment, the case has been described where the signal processing apparatus 10 estimates the signal parameters of the two signals from the superimposed signal containing two signals, but it is not limited to estimating the signal parameters of all the signals contained in the superimposed signal, and the signal processing apparatus may be configured to estimate at least one signal parameter. For example, the signal processing apparatus 10 may be configured to estimate the signal parameter of only a single signal of the superimposed signal. In this case, the signal processing apparatus 10 may be equipped with one each of the aforementioned first and second left and right peaks detecting units 14a, 14b and the first and second signal parameter estimating units 15a, 15b.

### Second Example Embodiment

A second example embodiment of the present disclosure will be described with reference to the drawings. The drawings may be related to any of the example embodiments.

### [Configuration]

The signal processing apparatus 10 in this example embodiment is configured almost similarly to the signal processing apparatus 10 shown in FIG. 1 in the first example embodiment described above, but there are some differences in configuration. Specifically, in the signal processing apparatus 10 of this example embodiment, the first left and right peaks detecting unit 14a and the second left and right peaks detecting unit 14b each detect both the left and right peaks of each signal, rather than either one. Accordingly, the first signal parameter estimating unit 15a and the second signal parameter estimating unit 15b in this example embodiment each estimate signal parameters for each signal from the results of detection of the central peak and both the left and right peaks. The detailed functions of each configuration will be explained in the following operation descriptions.

### [Operation]

Next, the operation of the signal processing apparatus 10 will be described. The signal processing apparatus 10 in this example embodiment operates as shown in the flowchart of FIG. 2 mainly in the same manner as in the first example embodiment. However, in this example embodiment, the operation differs at steps S4 and S5.

At step S4, the first left and right peaks detecting unit 14a outputs both the Fourier coefficients of the detected left and right peaks to the first signal parameter estimating unit 15a. Similarly, the second left and right peaks detecting unit 14b outputs both the Fourier coefficients of the detected left and right peaks to the second signal parameter estimating unit 15b.

At step S5, the first signal parameter estimating unit 15a estimates the signal parameter of the first signal based on the results of detection of the central peak and both the left and right peaks of the first signal. An example of a signal parameter estimation method using the result of detection of both the left and right peaks is estimating the signal parameters Aₙ and τₙ for each of the results of detection of the left and right peaks in the same manner as in the first example embodiment, and then determining the average of the result as the estimated value of the signal parameter. Similarly, the second signal parameter estimating unit 15b estimates the signal parameter of the second signal from the results of detection of the central peak and both the left and right peaks of the second signal.

Thus, in this example embodiment, the signal parameter is estimated using the results of detection of both the left and right peaks, so that it is possible to estimate the signal parameter with higher accuracy. Then, by separating the superimposed signal using the signal parameter, it is possible to achieve improvement of the accuracy of separation of the superimposed signal.

### Third Example Embodiment

A third example embodiment of the present disclosure will be described with reference to the drawings. The drawings may be related to any of the example embodiments.

### [Configuration]

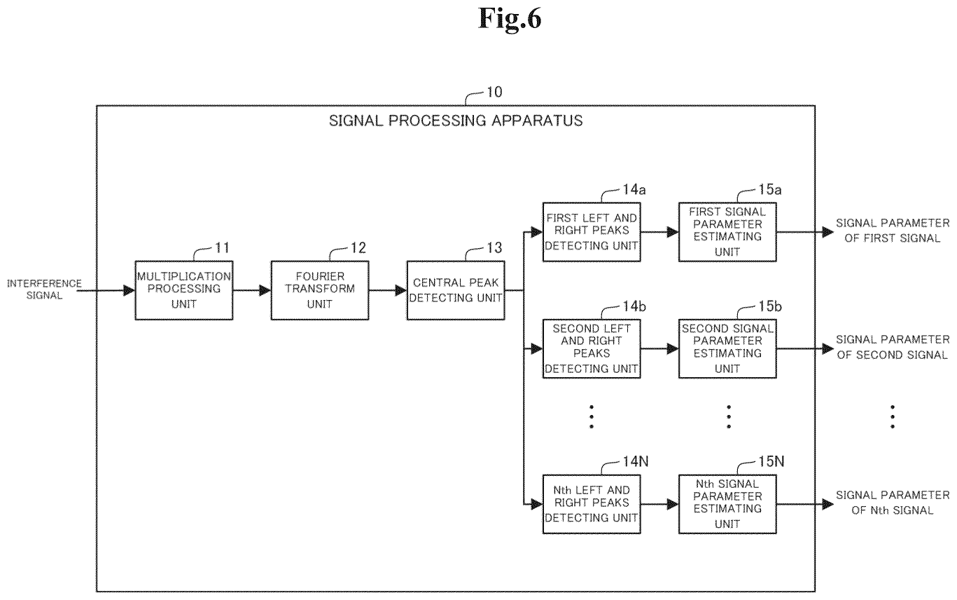

The signal processing apparatus 10 in this example embodiment has a configuration almost the same as the signal processing apparatus 10 shown in FIG. 1 in the aforementioned first and second example embodiments, but this configuration is further extended. Specifically, the signal processing apparatus 10 is capable of handling N signals contained in a superimposed signal and is configured to be able to estimate a signal parameter for each of the N signals. Specifically, as shown in FIG. 6, the signal processing apparatus 10 includes the multiplication processing unit 11, the Fourier transform unit 12, the central peak detecting unit 13, N left and right peaks detecting units 14a to 14N (first to N^{th} left and right peaks detecting units), and N signal parameter estimating units 15a to 15N (first to N^{th} signal parameter estimating units). In the following, a configuration different from those of the above example embodiments will be mainly described.

In this example embodiment, the central peak detecting unit 13 detects N central peaks corresponding to the N signals to be separated, from the multiplied waveform of a superimposed signal. Then, for the N signals corresponding to the N central peaks, the N left and right peaks detecting units 14a to 14N each detect either the left peak or the right peak or both the left and right peaks. Furthermore, for the N signals, the N signal parameter estimating units 15a to 15N each estimate a signal parameter from the results of detection of the central peak and one or two of the left and right peaks. The detailed functions of each configuration will be explained in the following operation description.

### [Operation]

Next, the operation of the signal processing apparatus 10 will be described. The signal processing apparatus 10 in this example embodiment operates mainly in the same manner as in the first and second example embodiments, as shown in the flowchart in FIG. 2. However, in this example embodiment, the repetition count of steps S4 and S5 differs.

First, as in the first and second example embodiments, the signal processing apparatus 10 estimates the signal parameter of the first signal by causing the first left and right peaks detecting unit 14a and the first signal parameter estimating unit 15a to execute steps S4 and S5 on the central peak of the first signal detected at step S3. Next, in the same manner as on the first signal, the signal processing apparatus 10 causes the second to N^{th} left and right peaks detecting units 14b to 14N and the second to N^{th} signal parameter estimating units 15b to N to execute steps S4 and S5 on the central peaks of the second to N^{th} signals detected at step S3 and thereby estimate the signal parameters of the second to N^{th} signals. In other words, the second to N^{th} left and right peaks detecting units 14b to 14N are caused to detect the left and right peaks of the second to N^{th} signals, respectively, based on the Fourier transform results and the central peak detection results of the second to N^{th} signals (step S4 of FIG. 2). Next, the second signal parameter estimating units 15b to the N^{th} signal parameter estimating unit 15N estimate the signal parameters of the second to N^{th} signals, respectively, based on the central peak detection results and the left and right peak detection results of the respective signals (step S5 in FIG. 2).

As described above, in this example embodiment, signal parameters are estimated using the N left and right peaks detecting units and the N signal parameter estimating units, it is possible to estimate the signal parameter of each signal from a superimposed signal contained N signals. Then, by using these signal parameters, it is possible to separate the N signals from the superimposed signal with high accuracy.

### Fourth Example Embodiment

Next, a fourth example embodiment of the present disclosure will be described with reference to the drawings. This example embodiment shows the overview of the signal processing apparatus and so forth described in the above example embodiments. The drawings may be related to any of the example embodiments.

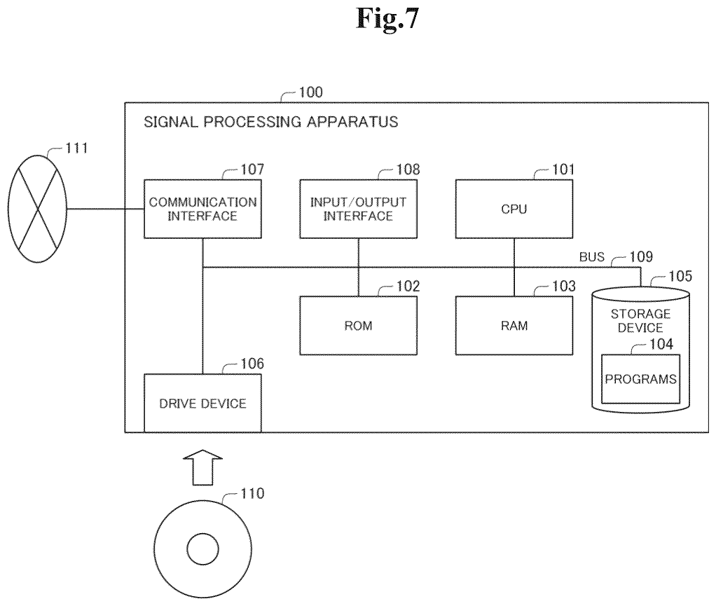

First, the hardware configuration of a signal processing apparatus 100 in the present disclosure will be described. The signal processing apparatus 100 is configured with a general-purpose information processing apparatus and is equipped with hardware components as shown in FIG. 7, for example, as follows.
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 7 shows an example of the hardware configuration of the information processing apparatus serving as the signal processing apparatus 100, and the hardware configuration of the information processing apparatus is not limited to the aforementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

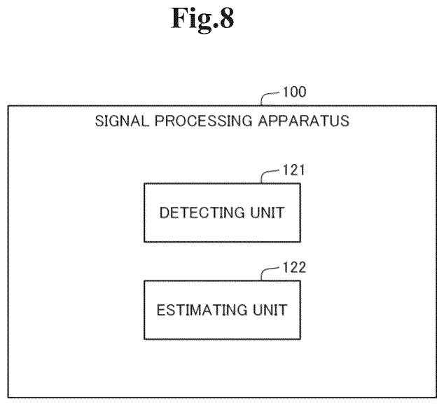

Then, the signal processing apparatus 100 can construct and include a detecting unit 121 and an estimating unit 122 shown in FIG. 8 by acquisition and execution of the programs 104 by the CPU 101. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the detection unit 121 and the estimation unit 122 described above may be constructed using dedicated electronic circuits for implementing such means.

The abovementioned detecting unit 121 detects, based on the intensity of a frequency component in a superimposed signal containing a plurality of signals, a first peak with the highest intensity and a second peak with lower intensity than the first peak in at least one signal to be separated that is contained by the superimposed signal. The abovementioned estimating unit 122 estimates a preset type of signal parameter of the signal to be separated, using information based on the first peak and the second peak.

With the configuration as described above, the present disclosure enables the estimation of a signal parameter of each signal contained in a superimposed signal. At this time, particularly, the peaks of frequency components originating from the respective superimposed signals contained are detected and the signal parameters are determined separately, so that it is possible to estimate the signal parameters even when the power difference between the signals contained in the superimposed signal is small. Furthermore, by focusing on the left and right peaks of the superimposed signal, a resampling process as preprocessing, which is required for signal parameter estimation utilizing the periodicity appearing when the sampling rate is the integral multiple of the symbol rate, becomes unnecessary, allowing for signal parameter estimation with reduced calculation amount. Then, it is possible to separate the superimposed signal by using the estimated signal parameters of the respective signals, and it is possible to achieve improvement of the accuracy of separation of a superimposed signal.

At least one or more of the aforementioned functions of the detecting unit 121 and the estimating unit 122 may be executed on any information processing apparatus installed and connected at any location on the network, that is, may be executed using so-called cloud computing.

Further, the abovementioned programs can be stored using various types of non-transitory computer-readable mediums and provided to a computer. The non-transitory computer-readable medium includes various types of tangible storage mediums. Examples of non-transitory computer-readable medium include magnetic recording medium (e.g., flexible disk, magnetic tape, hard disk drive), magneto-optical recording medium (e.g., magneto-optical disk), read only memory (CD-ROM), CD-R, CD-R/W, semiconductor memory (e.g., mask ROM, programmable ROM, Erasable PROM, flash ROM, random access memory (RAM)). In addition, a program may be provided to a computer by various types of temporary computer-readable medium. Examples of temporary computer-readable medium include electrical signals, optical signals, and electromagnetic waves. The temporary computer-readable medium may provide a program to the computer via a wired communication channel, such as an electric wire and an optical fiber, or a wireless communication channel.

Although the present disclosure has been described above with reference to example embodiments, the present disclosure is not limited to the example embodiments described above. The configuration and details of the present disclosure can be changed in a variety of ways that those skilled in the art can understand within the scope of the present disclosure. Then, each of the example embodiments described above can be combined with the other example embodiment as necessary.

### <Supplementary Notes>

The whole or part of the example embodiments disclosed above can be described as the following supplementary notes. Hereinafter, the overview of the configurations of an information processing apparatus, an information processing system, an information processing method, and a program in the present disclosure will be described. However, the present disclosure is not limited to the following configurations.

All or some of the configurations described in Supplementary Notes 2 to 8 dependent on Supplementary Note 1 below and the functions by such configurations may be dependent on other Supplementary Notes 9 and 10 by the same dependence as Supplementary Notes 2 to 8. Furthermore, not limited to Supplementary Notes 1, 9 and 10, within the scope of the example embodiments described above, some or all of the configurations described as supplementary notes and functions by such configurations may be dependent on hardware, software, various recording means for recording software, or system.

### (Supplementary Note 1)

A signal processing apparatus comprising:
a detecting unit configured to detect, based on intensity of a frequency component in a superimposed signal containing a plurality of signals, a first peak with highest intensity and a second peak with lower intensity than the first peak in at least one signal to be separated contained by the superimposed signal; and
an estimating unit configured to estimate a preset type of signal parameter of the signal to be separated by using information based on the first peak and the second peak.

### (Supplementary Note 2)

The signal processing apparatus according to supplementary note 1, wherein:
the detecting unit is configured to detect at least one second peak of the second peaks appearing on a low frequency side and a high frequency side, respectively, with respect to the first peak; and
the estimating unit is configured to estimate the preset type of signal parameter of the signal to be separated by using information based on the first peak and the at least one second peak.

### (Supplementary Note 3)

The signal processing apparatus according to supplementary note 1, wherein:
the detecting unit is configured to detect the two second peaks appearing on a low frequency side and a high frequency side, respectively, with respect to the first peak; and
the estimating unit is configured to estimate the preset type of signal parameter of the signal to be separated by using information based on the first peak and the two second peaks.

### (Supplementary Note 4)

The signal processing apparatus according to supplementary note 1, wherein
the estimating unit is configured to calculate amplitude of a carrier component of the signal to be separated and amplitude and phase of a signal component of amplitude modulation with respect to the carrier component by using the information based on the first peak and the second peak, and estimate the signal parameter by using the calculated information.

### (Supplementary Note 5)

The signal processing apparatus according to supplementary note 4, wherein
the estimating unit is configured to, by using the amplitude of the carrier component of the signal to be separated and the amplitude and phase of the signal component, estimate amplitude and symbol timing of the signal to be separated, as the signal parameter.

### (Supplementary Note 6)

The signal processing apparatus according to supplementary note 1, comprising
a converting unit configured to perform Fourier transform on a multiplied wave obtained by multiplying the superimposed signal,
wherein the detecting unit is configured to detect the first peak and the second peak of the signal to be separated based on a result of the Fourier transform.

### (Supplementary Note 7)

The signal processing apparatus according to supplementary note 6, wherein
the estimating unit is configured to, by using information related to the first peak and the second peak of the signal to be separated based on the result of the Fourier transform, calculate amplitude of a multiplied carrier component of the signal to be separated and amplitude and phase of a signal component of amplitude modulation with respect to the carrier component, and estimate the signal parameter based on the calculated information.

### (Supplementary Note 8)

The signal processing apparatus according to supplementary note 1, wherein:
the detecting unit is configured to detect the first peak and the second peak in each of a plurality of signals to be separated contained by the superimposed signal; and
the estimating unit is configured to estimate the signal parameter of each of the plurality of signals to be separated contained by the superimposed signal, by using information based on the detected first peak and second peak.

### (Supplementary Note 9)

A signal processing method comprising:
detecting, based on intensity of a frequency component in a superimposed signal containing a plurality of signals, a first peak with highest intensity and a second peak with lower intensity than the first peak in at least one signal to be separated contained by the superimposed signal; and
estimating a preset type of signal parameter of the signal to be separated by using information based on the first peak and the second peak.

### (Supplementary Note 9.1)

The signal processing method according to supplementary note 9, comprising:
detecting at least one second peak of the second peaks appearing on a low frequency side and a high frequency side, respectively, with respect to the first peak; and
estimating the preset type of signal parameter of the signal to be separated by using information based on the first peak and the at least one second peak.

### (Supplementary Note 9.2)

The signal processing method according to supplementary note 9, comprising:
detecting the two second peaks appearing on a low frequency side and a high frequency side, respectively, with respect to the first peak; and
estimating the preset type of signal parameter of the signal to be separated by using information based on the first peak and the two second peaks.

### (Supplementary Note 9.3)

The signal processing method according to supplementary note 9, comprising:
calculating amplitude of a carrier component of the signal to be separated and amplitude and phase of a signal component of amplitude modulation with respect to the carrier component by using the information based on the first peak and the second peak, and estimating the signal parameter by using the calculated information.

### (Supplementary Note 9.4)

The signal processing method according to supplementary note 9.3, comprising
by using the amplitude of the carrier component of the signal to be separated and the amplitude and phase of the signal component, estimating amplitude and symbol timing of the signal to be separated, as the signal parameter.

### (Supplementary Note 9.5)

The signal processing method according to supplementary note 9, comprising
performing Fourier transform on a multiplied wave obtained by multiplying the superimposed signal; and
detecting the first peak and the second peak of the signal to be separated based on a result of the Fourier transform.

### (Supplementary Note 9.6)

The signal processing method according to supplementary note 9.5, comprising
by using information related to the first peak and the second peak of the signal to be separated based on the result of the Fourier transform, calculating amplitude of a multiplied carrier component of the signal to be separated and amplitude and phase of a signal component of amplitude modulation with respect to the carrier component, and estimating the signal parameter based on the calculated information.

### (Supplementary Note 9.7)

The signal processing method according to supplementary note 9, comprising:
detecting the first peak and the second peak in each of a plurality of signals to be separated contained by the superimposed signal; and
estimating the signal parameter of each of the plurality of signals to be separated contained by the superimposed signal, by using information based on the detected first peak and second peak.

### (Supplementary Note 10)

A program comprising instructions for causing a computer to execute processes to:
detect, based on intensity of a frequency component in a superimposed signal containing a plurality of signals, a first peak with highest intensity and a second peak with lower intensity than the first peak in at least one signal to be separated contained by the superimposed signal; and
estimate a preset type of signal parameter of the signal to be separated by using information based on the first peak and the second peak.

### REFERENCE SIGNS LIST

10 signal processing apparatus
11 multiplication processing unit
12 Fourier transform unit
13 central peak detecting unit
14a first left and right peaks detecting unit
14b second left and right peaks detecting unit
14N N^{th} left and right peaks detecting unit
15a first signal parameter estimating unit
15b second signal parameter estimating unit
15N N^{th} signal parameter estimating unit
100 signal processing apparatus
101 CPU
102 ROM
103 RAM
104 programs
105 storage device
106 drive device
107 communication interface
108 input/output interface
109 bus
110 storage medium
111 communication network
121 detecting unit
122 estimating unit

1. A signal processing apparatus comprising:
at least one memory storing processing instructions; and
at least one processor configured to execute the processing instructions to:
detect, based on intensity of a frequency component in a superimposed signal containing a plurality of signals, a first peak with highest intensity and a second peak with lower intensity than the first peak in at least one signal to be separated contained by the superimposed signal; and
estimate a preset type of signal parameter of the signal to be separated by using information based on the first peak and the second peak.

2. The signal processing apparatus according to claim 1, wherein the at least one processor is configured to execute the processing instructions to:
detect at least one second peak of the second peaks appearing on a low frequency side and a high frequency side, respectively, with respect to the first peak; and
estimate the preset type of signal parameter of the signal to be separated by using information based on the first peak and the at least one second peak.

3. The signal processing apparatus according to claim 1, wherein the at least one processor is configured to execute the processing instructions to:
detect the two second peaks appearing on a low frequency side and a high frequency side, respectively, with respect to the first peak; and
estimate the preset type of signal parameter of the signal to be separated by using information based on the first peak and the two second peaks.

4. The signal processing apparatus according to claim 1, wherein the at least one processor is configured to execute the processing instructions to
calculate amplitude of a carrier component of the signal to be separated and amplitude and phase of a signal component of amplitude modulation with respect to the carrier component by using the information based on the first peak and the second peak, and estimate the signal parameter by using the calculated information.

5. The signal processing apparatus according to claim 4, wherein the at least one processor is configured to execute the processing instructions to
by using the amplitude of the carrier component of the signal to be separated and the amplitude and phase of the signal component, estimate amplitude and symbol timing of the signal to be separated, as the signal parameter.

6. The signal processing apparatus according to claim 1, wherein the at least one processor is configured to execute the processing instructions to:
perform Fourier transform on a multiplied wave obtained by multiplying the superimposed signal; and furthermore
detect the first peak and the second peak of the signal to be separated based on a result of the Fourier transform.

7. The signal processing apparatus according to claim 6, wherein the at least one processor is configured to execute the processing instructions to
by using information related to the first peak and the second peak of the signal to be separated based on the result of the Fourier transform, calculate amplitude of a multiplied carrier component of the signal to be separated and amplitude and phase of a signal component of amplitude modulation with respect to the carrier component, and estimate the signal parameter based on the calculated information.

8. The signal processing apparatus according to claim 1, wherein the at least one processor is configured to execute the processing instructions to:
detect the first peak and the second peak in each of a plurality of signals to be separated contained by the superimposed signal; and
estimate the signal parameter of each of the plurality of signals to be separated contained by the superimposed signal, by using information based on the detected first peak and second peak.

9. A signal processing method comprising:
detecting, based on intensity of a frequency component in a superimposed signal containing a plurality of signals, a first peak with highest intensity and a second peak with lower intensity than the first peak in at least one signal to be separated contained by the superimposed signal; and
estimating a preset type of signal parameter of the signal to be separated by using information based on the first peak and the second peak.

10. The signal processing method according to claim 9, comprising:
detecting at least one second peak of the second peaks appearing on a low frequency side and a high frequency side, respectively, with respect to the first peak; and
estimating the preset type of signal parameter of the signal to be separated by using information based on the first peak and the at least one second peak.

11. The signal processing method according to claim 9, comprising:
detecting the two second peaks appearing on a low frequency side and a high frequency side, respectively, with respect to the first peak; and
estimating the preset type of signal parameter of the signal to be separated by using information based on the first peak and the two second peaks.

12. The signal processing method according to claim 9, comprising:
calculating amplitude of a carrier component of the signal to be separated and amplitude and phase of a signal component of amplitude modulation with respect to the carrier component by using the information based on the first peak and the second peak, and estimating the signal parameter by using the calculated information.

13. The signal processing method according to claim 9, comprising
by using the amplitude of the carrier component of the signal to be separated and the amplitude and phase of the signal component, estimating amplitude and symbol timing of the signal to be separated, as the signal parameter.

14. The signal processing method according to claim 9, comprising
performing Fourier transform on a multiplied wave obtained by multiplying the superimposed signal; and
detecting the first peak and the second peak of the signal to be separated based on a result of the Fourier transform.

15. The signal processing method according to claim 14, comprising
by using information related to the first peak and the second peak of the signal to be separated based on the result of the Fourier transform, calculating amplitude of a multiplied carrier component of the signal to be separated and amplitude and phase of a signal component of amplitude modulation with respect to the carrier component, and estimating the signal parameter based on the calculated information.

16. The signal processing method according to claim 9, comprising:
detecting the first peak and the second peak in each of a plurality of signals to be separated contained by the superimposed signal; and
estimating the signal parameter of each of the plurality of signals to be separated contained by the superimposed signal, by using information based on the detected first peak and second peak.

17. A non-transitory computer-readable storage medium storing a program comprising instructions for causing a computer to execute processes to:
detect, based on intensity of a frequency component in a superimposed signal containing a plurality of signals, a first peak with highest intensity and a second peak with lower intensity than the first peak in at least one signal to be separated contained by the superimposed signal; and
estimate a preset type of signal parameter of the signal to be separated by using information based on the first peak and the second peak.
